(19) United States
(12) Patent Application Publication
(10) Pub. No.: US 2003/0190510 A1
(43) Pub. Date: Oct. 9, 2003

(54) Apparatus and method for monitoring individual cells in a fuel-cell based electrical power source

(76) Inventors: James Musselman, San Diego, CA (US); Charles M. Holmes, Escondido, CA (US)

Correspondence Address: ROBROY R FAWCETT, 1576 KATELLA WAY, ESCONDIDO, CA, 92027, US

(21) Appl. No.: 10/117,784

(22) Filed: Apr. 4, 2002

(51) Int. Cl. H01M 8/04; H01M 12/06

(52) U.S. Cl. 429/23; 429/27; 429/13; 700/298

(57) ABSTRACT

The present invention may be embodied in an apparatus, and related method, for monitoring an individual cell in a fuel cell in an electrical power source. The monitoring apparatus includes a plurality of individual cells, a first switch network, a capacitor, a second switch network, and a voltage measurement circuit. The plurality of individual cells electrically may be stacked in series. The first switch network is coupled between the plurality of cells and the capacitor for momentarily coupling a selected cell to the capacitor. The second switch network is coupled between the capacitor and the measurement circuit for momentarily coupling the capacitor to the measurement circuit for permitting measurement of the voltage across the capacitor for monitoring selected cells. The capacitor may be a floating capacitor that is electrically isolated from a reference voltage of the monitoring apparatus when not coupled by the second network to the measurement circuit.

### FIELD OF THE INVENTION

The present invention relates generally to fuel cells, and, more specifically, to metal fuel cells, and monitoring individual cells in a fuel cell or in an electrochemical power system employing the same.

### RELATED ART

An electrochemical power source can include one or more fuel cells coupled to a power bus. Each fuel cell can include a fuel cell stack, which can include individual cells connected in series between suitable terminals of the power bus. An individual cell in a stack may experience an abnormal condition that may cause permanent damage to the fuel cell, or may create a hazard, if the abnormal condition is allowed to continue. However, monitoring the voltage from the fuel cell stack may not provide an indication that an individual cell in the stack may be experiencing an abnormal condition.

### SUMMARY

In one aspect, the invention comprises apparatus for monitoring at least one individual cell in a fuel cell of an electrochemical power source. A monitoring apparatus in accordance with the invention comprises at least one individual cell(s), a first switch network, a capacitor, a second switch network, and a voltage measurement circuit. The at least one individual cell(s) can be electrically coupled (in series and/or in parallel) between the terminals of a bus of the electrochemical power source. The first switch network can be coupled between the at least one individual cell(s) and the capacitor for momentarily coupling one or more selected individual cell(s) to the capacitor for inducing a voltage from the one or more selected individual cell(s) onto the capacitor. The second switch network can be coupled between the capacitor and the voltage measurement circuit for momentarily coupling the capacitor to the measurement circuit to permit the measurement circuit to measure the induced voltage across the capacitor for monitoring the selected individual cell(s).

In one embodiment of the invention, the capacitor can be a floating capacitor that is electrically isolated from a reference voltage of the monitoring apparatus when not coupled by the second switch network to the voltage measurement circuit. Alternatively or in addition, the reference voltage can be an electrical system ground for the monitoring apparatus, and/or the momentary coupling between the selected individual cell(s) and the capacitor by the first switch network and the momentary coupling between the capacitor and the voltage measurement circuit can be timed such that no simultaneous current circuit path exists between selected individual cell(s) and the voltage measurement circuit through the first and second switch networks.

In another embodiment of the invention, the monitoring apparatus further comprises means for determining and indicating whether the selected individual cell(s) is operating within predetermined limits based on the measurement of the induced voltage of the capacitor.

In a further embodiment of the invention, the second switch network selectably can couple the capacitor to the measurement circuit such that the voltage measured by the measurement circuit is inverted.

In an additional aspect, the invention comprises testing apparatus that can be configured in substantially the same way as the monitoring apparatus in accordance with the invention.

In another aspect, the invention comprises suitable components, or subcombinations of the elements, of apparatus in accordance with the invention.

In an additional aspect, the invention comprises novel fuel cell subsystems. Typically, these fuel cell subsystems comprise at least one monitoring and/or testing apparatus in accordance with the invention. These fuel cell subsystems can be suitable for many applications, including without limitation use in a fuel cell and/or use to test operability of various fuel cell components.

In a further aspect, the invention comprises novel fuel cells. Typically, these fuel cells comprise at least one monitoring and/or testing apparatus in accordance with the invention. These fuel cells can be suitable for many applications, including without limitation use in supplying power to load(s).

In another aspect, the invention comprises methods for monitoring at least one individual cell in a fuel cell of an electrochemical power source. In an additional aspect, the invention comprises methods for testing the health of at least one individual cell of a cell stack of a fuel cell and/or the fuel cell stack itself.

Monitoring and/or testing method(s) according to the invention can comprise selecting for a voltage measurement one or more individual cell(s) from a plurality of individual cells that are electrically coupled (in series and/or in parallel) between the terminals of a bus of the electrochemical power source. The method(s) further can comprise coupling the selected individual cell(s) to a floating capacitor to induce the voltage of the selected individual cell(s) onto the floating capacitor. The method(s) also can comprise electrically isolating (e.g., disconnecting) the floating capacitor from the selected individual cell(s). The method(s) then can comprise coupling the floating capacitor to a measurement circuit for measuring the floating capacitor's induced voltage for monitoring the selected individual cell(s)' voltage(s). The method(s) optionally can be repeated for one or more of the remaining individual cells in the fuel cell stack. The method(s) further can comprise determining and indicating whether the selected individual cell(s) is operating within a predetermined voltage range.

In a further aspect, the invention comprises suitable submethods, or subcombinations of the steps, of a method in accordance with the invention.

### BRIEF DESCRIPTION OF THE DRAWINGS

The accompanying drawings illustrate embodiments of the present invention. The components in the accompanying drawings are not necessarily to scale but, together with the description, serve to explain some principles of the invention.

FIG. 1A is a simplified block diagram of an electrochemical power source system.

FIG. 1B is a simplified block diagram of an alternate embodiment of an electrochemical power source system.

FIG. 1C is a schematic diagram of an apparatus for monitoring the output voltage of a selected individual cell of a fuel cell stack, according to the present invention.

FIG. 2 is a schematic diagram of a first switch network of the individual cell monitoring apparatus of FIG. 1C.

FIG. 3 is a schematic diagram of a second switch network of the individual cell monitoring apparatus of FIG. 1C.

FIG. 4 is a block diagram of a method for monitoring the output voltage of a selected individual cell in a fuel cell stack, according to the present invention.

### DETAILED DESCRIPTION

As utilized herein, terms such as “approximately,” “about” and “substantially” are intended to allow some leeway in mathematical exactness to account for tolerances that are acceptable in the trade, e.g., any deviation upward or downward from the value modified by “approximately,” “about” or “substantially” by any value in the range(s) from 1% to 20% of such value.

As employed herein, the terms or phrases “in the range(s)” or “between” comprises the range defined by the values listed after the term “in the range(s)” or “between”, as well as any and all subranges contained within such range, where each such subrange is defined as having as a first endpoint any value in such range, and as a second endpoint (if any) any value in such range that is greater than the first endpoint and that is in such range.

As utilized herein, the term “logic” comprises hardware, software, and combinations of hardware and software, and the term “microprocessor” comprises “logic” possibly in combination with one or more electromechanical devices or apparatus, such as sensors or measuring devices or calculating devices or the like.

As employed herein, the term “indicate” and grammatical variants thereof comprise any machine or human perceptible form, such as a signal, a human perceivable meter reading, a logic perceivable meter reading, or the like, or suitable combinations of any two or more thereof.

Introduction to Fuel Cells and Electrochemical Power Systems Employing Fuel Cells

A hydrogen fuel cell is a fuel cell that uses a hydrogen-containing compound, such as hydrogen gas or liquid, as a fuel. A metal fuel cell is a fuel cell that uses a metal, such as zinc particles, as fuel. In a metal fuel cell, the fuel is generally stored, transmitted and used in the presence of a reaction medium, such as potassium hydroxide solution.

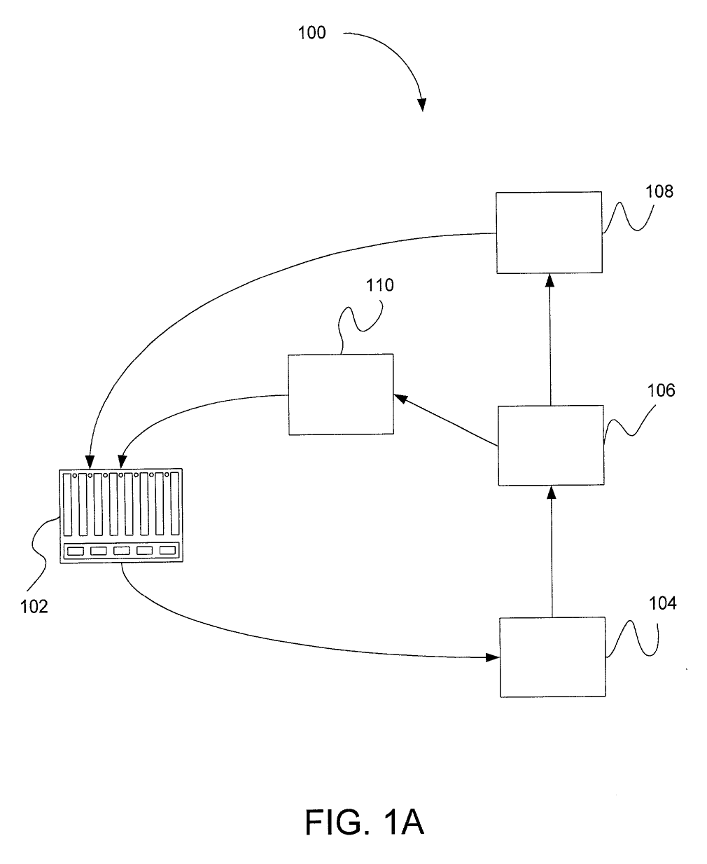

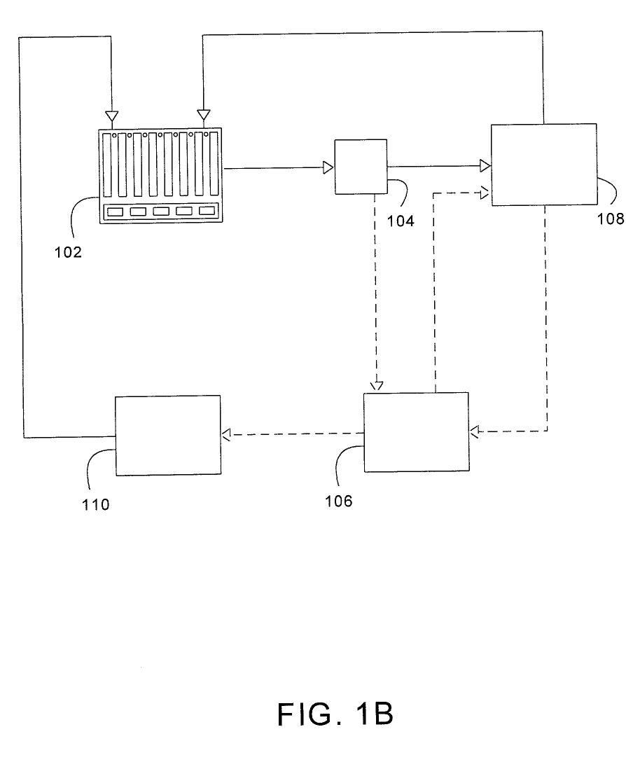

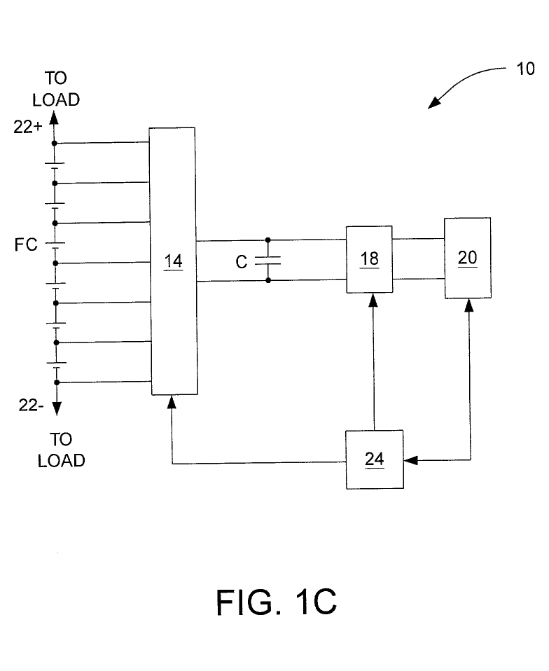

A block diagram of a fuel cell is illustrated in FIG. 1. As illustrated, the fuel cell comprises a power source 102, an optional reaction product storage unit 104, an optional regeneration unit 106, a fuel storage unit 108, and an optional second reactant storage unit 110.

The power source 102 in turn comprises one or more individual cells each having a cell body defining a cell cavity, with an anode and cathode situated in each cell cavity. The individual cells can be coupled in parallel or series, or independently coupled to different electrical loads. In one implementation, they are coupled in series. The number of individual cells coupled together to form a cell stack can vary in the range(s) from 2 to 10000 or more. The health, or ability to operate, of an individual cell, and of any group of such individual cells (including without limitation the cell stack comprising a plurality of such individual cells), can be determined by, among other methods, measuring an electrical property (e.g., voltage, or the like) of one or more of such individual cells to determine whether this electrical property falls within predetermined limits of the electrical property.

An individual cell (or a group of such individual cells) can be determined to be unhealthy (i.e., fail to operate within specific predetermined limits of an electrical property (e.g., voltage or the like)) for a variety of reasons. In the case of an exemplary individual cell (or group of such individual cells) that utilizes zinc as a fuel, these reasons include without limitation the zinc fuel particles becoming exhausted; a clog forming inside the individual cell(s), thereby preventing or obstructing the flow of zinc fuel particles and/or reaction medium; the reaction medium contained within the individual cell(s) becoming contaminated or otherwise chemically incorrect; the individual cell(s) becoming overloaded beyond the individual cell(s)' rated power capacity, thereby causing overheating, release of dangerous reaction medium into the surroundings, or other potentially permanent damage; and/or the like; and/or suitable combinations of any two or more thereof. A group of individual cells (e.g., a cell stack) comprising one or more individual cell(s) judged to be unhealthy can be disconnected from the electrochemical power source and safely shut down, thereby permitting the repair and/or replacement of the unhealthy individual cell(s) within the group.

In the case where this electrical property is voltage, suitable ranges of predetermined voltage limits for determining and/or indicating whether individual cell(s) of a cell stack of a fuel cell (or groups of such individual cell(s)) are healthy or unhealthy can be readily determined. Typically, an individual cell of a cell stack of a fuel cell (or groups of such individual cell(s)) is determined to be healthy if its voltage is not less than a value in the range(s) from about 10% to about 50% of its normal, theoretical operating voltage (e.g., theoretical voltage between the anode and the cathode of the individual cell (or groups of such individual cell(s)) based on, among other measurements, the respective potential(s) versus SHE (standard hydrogen electrode) reference at open circuit). Conversely, an individual cell of a cell stack of a fuel cell (or groups of such individual cell(s)) is determined to be unhealthy if its voltage is less than a value in the range(s) from about 10% to about 50% of its normal, theoretical operating voltage.

Continuing with a description of a fuel cell, the anodes within the cell cavities in power source 102 comprise the fuel stored in fuel storage unit 108 or an electrode. Within the cell cavities of power source 102, an electrochemical reaction takes place whereby the anode releases electrons, and forms one or more reaction products. Through this process, the anodes are gradually consumed.

The electrons released from the electrochemical reaction at the anode flow through a load to the cathode, where they react with one or more second reactants from an optional second reactant storage unit 110 or from some other source. This flow of electrons through the load gives rise to an over-potential (i.e., work) required to drive the demanded current, which over-potential acts to decrease the theoretical voltage between the anode and the cathode. This theoretical voltage arises due to the difference in electrochemical potential between the anode (for example, in the case of a zinc fuel cell, Zn potential of −1.215V versus SHE reference at open circuit) and cathode (O₂ potential of +0.401V versus SHE reference at open circuit). When the cells are combined in series, the sum of the voltages for the cells forms the output of the power source.

The one or more reaction products can then be provided to optional reaction product storage unit 104 or to some other destination. The one or more reaction products, from reaction product storage unit 104 or some other source, can then be provided to optional regeneration unit 106, which regenerates fuel and/or one or more of the second reactants from the one or more reaction products. The regenerated fuel can then be provided to fuel storage unit 108, and/or the regenerated one or more second reactants can then be provided to optional second reactant storage unit 110 or to some other destination. As an alternative to regenerating the fuel from the reaction product using the optional regeneration unit 106, the fuel can be inserted into the system from an external source and the reaction product can be withdrawn from the system.

The optional reaction product storage unit 104 comprises a unit that can store the reaction product. Exemplary reaction product storage units include without limitation one or more tanks, one or more sponges, one or more containers, one or more vats, one or more canister, one or more chambers, one or more cylinders, one or more cavities, one or more barrels, one or more vessels, and the like, including without limitation those found in or which may be formed in a substrate, and suitable combinations of any two or more thereof. Optionally, the optional reaction product storage unit 104 is detachably attached to the system.

The optional regeneration unit 106 comprises a unit that can electrolyze the reaction product(s) back into fuel (e.g., hydrogen-containing compounds, including without limitation hydrogen; electroactive particles, including without limitation metal particles and/or metal-coated particles; electroactive electrodes; and the like; and suitable combinations of any two or more thereof) and/or second reactant (e.g., air, oxygen, hydrogen peroxide, other oxidizing agents, and the like, and suitable combinations of any two or more thereof). Exemplary regeneration units include without limitation water electrolyzers (which regenerate an exemplary second reactant (oxygen) and/or fuel (hydrogen) by electrolyzing water); metal (e.g., zinc) electrolyzers (which regenerate a fuel (e.g., zinc) and a second reactant (e.g., oxygen) by electrolyzing a reaction product (e.g., zinc oxide (ZnO)); and the like; and suitable combinations of any two or more thereof. Exemplary metal electrolyzers include without limitation fluidized bed electrolyzers, spouted bed electrolyzers, and the like, including without limitation those found in or which may be formed in a substrate, and suitable combinations of two or more thereof. The power source 102 can optionally function as the optional regeneration unit 106 by operating in reverse, thereby foregoing the need for a regeneration unit 106 separate from the power source 102. Optionally, the optional regeneration unit 106 is detachably attached to the system.

The fuel storage unit 108 comprises a unit that can store the fuel (e.g., for metal fuel cells, electroactive particles, including without limitation metal (or metal-coated) particles, liquid born metal (or metal-coated) particles, and the like; electroactive electrodes, and the like, and suitable combinations of any two or more thereof; for hydrogen fuel cells, hydrogen or hydrogen-containing compounds that can be reformed into a usable fuel prior to consumption; for alcohol fuel cells, alcohol or alcohol-containing compounds). Exemplary fuel storage units include without limitation one or more of any of the enumerated types of reaction product storage units, which in one embodiment are made of a substantially non-reactive material (e.g., stainless steel, plastic, or the like), for holding potassium hydroxide (KOH) and metal (e.g., zinc (Zn), other metals, and the like) particles, separately or together; a high-pressure tank for gaseous fuel (e.g., hydrogen gas); a cryogenic tank for liquid fuel (e.g., liquid hydrogen) which is a gas at operating temperature (e.g., room temperature); a metal-hydride-filled tank for holding hydrogen; a carbon-nanotube-filled tank for storing hydrogen; and the like; and suitable combinations of any two or more thereof. Optionally, the fuel storage unit 108 is detachably attached to the system.

The optional second reactant storage unit 10 comprises a unit that can store the second reactant. Exemplary second reactant storage units include without limitation one or more tanks (for example, without limitation, a high-pressure tank for gaseous second reactant (e.g., oxygen gas), a cryogenic tank for liquid second reactant (e.g., liquid oxygen) which is a gas at operating temperature (e.g., room temperature), a tank for a second reactant which is a liquid or solid at operating temperature (e.g., room temperature), and the like), one or more of any of the enumerated types of reaction product storage units, which in one embodiment are made of a substantially non-reactive material, and the like, and suitable combinations of any two or more thereof. Optionally, the optional second reactant storage unit 1100 is detachably attached to the system.

In one embodiment of a fuel cell useful in the practice of the invention, the fuel cell is a metal fuel cell. The fuel of a metal fuel cell is a metal that can be in a form to facilitate entry into the cell cavities of the power source 102. For example, the fuel can be in the form of metal (or metal-coated) particles or liquid born metal (or metal-coated) particles or suitable combinations thereof. Exemplary metals for the metal (or metal-coated) particles include without limitation zinc, aluminum, lithium, magnesium, iron, sodium, and the like. Suitable alloys of such metals can also be utilized for the metal (or metal-coated) particles.

In this embodiment, when the fuel is optionally already present in the anode of the cell cavities in power source 102 prior to activating the fuel cell, the fuel cell is pre-charged, and can start-up significantly faster than when there is no fuel in the cell cavities and/or can run for a time in the range(s) from about 0.001 minutes to about 1000 minutes without additional fuel being moved into the cell cavities. The amount of time which the fuel cell can run on a pre-charge of fuel within the cell cavities can vary with, among other factors, the pressurization of the fuel within the cell cavities, and the power drawn from the fuel cell, and alternative embodiments of this aspect of the invention permit such amount of time to be in the range(s) from about 1 second to about 1000 minutes or more, and in the range(s) from about 30 seconds to about 1000 minutes or more.

Moreover, the second reactant optionally can be present in the fuel cell and pre-pressurized to any pressure in the range(s) from about 0 psi gauge pressure to about 200 psi gauge pressure. Furthermore, in this embodiment, one optional aspect provides that the volumes of one or both of the fuel storage unit 108 and the optional second reactant storage unit 110 can be independently changed as required to independently vary the energy of the system from its power, in view of the requirements of the system. Suitable such volumes can be calculated by utilizing, among other factors, the energy density of the system, the energy requirements of the one or more loads of the system, and the time requirements for the one or more loads of the system. In one embodiment, these volumes can vary in the range(s) from about 10-102 liters to about 1,000,000 liters. In another embodiment, the volumes can vary in the range(s) from about 10-102 liters to about 10 liters.

In one aspect of this embodiment, at least one of, and optionally all of, the metal fuel cell(s) is a zinc fuel cell in which the fuel is in the form of fluid borne zinc particles immersed in a potassium hydroxide (KOH) electrolytic reaction solution, and the anodes within the cell cavities are particulate anodes formed of the zinc particles. In this embodiment, the reaction products can be the zincate ion, Zn(OH)₂⁴⁻, or zinc oxide, ZnO, and the one or more second reactants can be an oxidant (for example, oxygen (taken alone, or in any organic or aqueous (e.g., water-containing) fluid (for example and without limitation, liquid or gas (e.g., air)), hydrogen peroxide, and the like, and suitable combinations of any two or more thereof). When the second reactant is oxygen, the oxygen can be provided from the ambient air (in which case the optional second reactant storage unit 110 can be excluded), or from the second reactant storage unit 110. Similarly, when the second reactant is oxygen in water, the water can be provided from the second reactant storage unit 110, or from some other source, e.g., tap water (in which case the optional second reactant storage unit 110 can be excluded). In order to replenish the cathode, to deliver second reactant(s) to the cathodic area, and to facilitate ion exchange between the anodes and cathodes, a flow of the second reactant(s) can be maintained through a portion of the cells. This flow optionally can be maintained through one or more pumps (not shown in FIG. 1), blowers or the like, or through some other means. If the second reactant is air, it optionally can be pre-processed to remove CO₂ by, for example, passing the air through soda lime. This is generally known to improve performance of the fuel cell.

In this embodiment, the particulate fuel of the anodes is gradually consumed through electrochemical dissolution. In order to replenish the anodes, to deliver KOH to the anodes, and to facilitate ion exchange between the anodes and cathodes, a recirculating flow of the fluid borne zinc particles can be maintained through the cell cavities. This flow can be maintained through one or more pumps (not shown), convection, flow from a pressurized source, or through some other means.

As the potassium hydroxide contacts the zinc anodes, the following reaction takes place at the anodes:

Zn+4OH⁻→Zn(OH)₄²⁻+2e (1)

The two released electrons flow through a load to the cathode where the following reaction takes place:

$$\frac{1}{2} {O}_{2} + 2 {e}^{-} + {H}_{2} O \to 2 O {H}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Z n + 2 O {H}^{-} + \frac{1}{2} {O}_{2} + {H}_{2} O \to Z {n ( O H )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻ (4)

In this case, the overall reaction which occurs in the cell cavities is the combination of the three reactions (1), (2), and (4). This overall reaction can be expressed as follows:

$$Z n + \frac{1}{2} {O}_{2} \to Z n O \qquad ( 5 )$$

Under real world conditions, the reactions (4) or (5) yield an open-circuit voltage potential of about 1.4V. For additional information on this embodiment of a zinc/air battery or fuel cell, the reader is referred to U.S. Pat. Nos. 5,952,117; 6,153,329; and 6,162,555, which are hereby incorporated by reference herein as though set forth in full.

The reaction product Zn(OH)₄²⁻, and also possibly ZnO, can be provided to reaction product storage unit 104. Optional regeneration unit 106 can then reprocess these reaction products to yield oxygen, which can be released to the ambient air or stored in second reactant storage unit 110, and zinc particles, which are provided to fuel storage unit 108. In addition, the optional regeneration unit 106 can yield water, which can be discharged through a drain or stored in second reactant storage unit 110 or fuel storage unit 108. It can also regenerate hydroxide, OH⁻, which can be discharged or combined with potassium ions to yield the potassium hydroxide reaction solution.

The regeneration of the zincate ion, Zn(OH)₄²-, into zinc, and one or more second reactants can occur according to the following overall reaction:

$$Z {n ( O H )}_{4}^{2 -} \to Z n + 2 O {H}^{-} + {H}_{2} O + \frac{1}{2} {O}_{2} \qquad ( 6 )$$

The regeneration of zinc oxide, ZnO, into zinc, and one or more second reactants can occur according to the following overall reaction:

$$ZnO \to Zn + \frac{1}{2} {O}_{2} \qquad ( 7 )$$

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, sodium fuel cells, and the like are possible, as are metal fuel cells where the fuel is not in particulate form but in another form such as without limitation sheets, ribbons, strings, slabs, plates, or the like, or suitable combinations of any two or more thereof. Embodiments are also possible in which the fuel is not fluid borne or continuously re-circulated through the cell cavities (e.g., porous plates of fuel, ribbons of fuel being cycled past a reaction zone, and the like). It is also possible to avoid an electrolytic reaction solution altogether or at least employ reaction solutions besides potassium hydroxide, for example, without limitation, sodium hydroxide, inorganic alkalis, alkali or alkaline earth metal hydroxides or aqueous salts such as sodium chloride. See, for example, U.S. Pat. No. 5,958,210, the entire contents of which are incorporated herein by this reference. It is also possible to employ metal fuel cells that output AC power rather than DC power using an inverter, a voltage converter, or the like, or suitable combinations of any two or more thereof.

In another embodiment of a fuel cell useful in the practice of the invention, the fuel used in the electrochemical reaction that occurs within the cells is hydrogen, the second reactant is oxygen, and the reaction product is water. In one aspect, the hydrogen fuel is maintained in the fuel storage unit 108, but the second reactant storage unit 110 can be omitted and the oxygen used in the electrochemical reaction within the cells can be taken from the ambient air. In another aspect, the hydrogen fuel is maintained in the fuel storage unit 108, and the oxygen is maintained in the second reactant storage unit 110. In addition, the optional reaction product storage unit 104 can be included or omitted, and the water resulting from discharge of the unit simply discarded or stored in the reaction product storage unit 104 (if present), respectively. Later, the optional regeneration unit 106 can regenerate water from another source, such as tap water or distilled water, or from the reaction product storage unit 104 (if present) into hydrogen and oxygen. The hydrogen can then be stored in fuel storage unit 104, and the oxygen simply released into the ambient air or maintained in the second reactant storage unit 110.

In a further embodiment of a fuel cell useful in the practice of the invention, a metal fuel cell system is provided. Such system is characterized in that it has one, or any suitable combination of two or more, of the following properties: the system optionally can be configured to not utilize or produce significant quantities of flammable fuel or product, respectively; the system can provide primary and/or auxiliary/backup power to the one or more loads for an amount of time limited only by the amount of fuel present (e.g., in the range(s) from about 0.01 hours to about 10,000 hours or more, and in the range(s) from about 0.5 hours to about 650 hours, or more); the system optionally can be configured to have an energy density in the range(s) from about 35 Watt-hours per kilogram of combined fuel and electrolyte (reaction medium) added to about 400 Watt-hours per kilogram of combined fuel and electrolyte added; the system optionally can further comprise an energy requirement and can be configured such that the combined volume of fuel and electrolyte added to the system is in the range(s) from about 0.0028 L per Watt-hour of the system's energy requirement to about 0.025 L per Watt-hour of the system's energy requirement, and this energy requirement can be calculated in view of, among other factors, the energy requirement(s) of the one or more load(s) comprising the system (In one embodiment, the energy requirement of the system can be in the range(s) from 50 Watt-hours to about 500,000 Watt-hours, whereas in another embodiment, the energy requirement of the system can be in the range(s) from 5 Watt-hours to about 50,000,000 Watt-hours; in yet another embodiment, the energy requirement can range from 5×10⁻¹² Watt-hours to 50,000 Watt-hours); the system optionally can be configured to have a fuel storage unit that can store fuel at an internal pressure in the range(s) from about −5 pounds per square inch (psi) gauge pressure to about 200 psi gauge pressure; the system optionally can be configured to operate normally while generating noise in the range(s) from about 1 dB to about 50 dB (when measured at a distance of about 10 meters therefrom), and alternatively in the range(s) of less than about 50 dB (when measured at a distance of about 10 meters therefrom). In one implementation, this metal fuel cell system comprises a zinc fuel cell system.

FIG. 1B is a block diagram of an alternative embodiment of a metal-based fuel cell in which, compared to FIG. 1A, like elements are referenced with like identifying numerals. Dashed lines are flow paths for the recirculating reaction solution when the optional regeneration unit is present and running. Solid lines are flow paths for the recirculating anode fluid when the fuel cell system is running in idle or discharge mode. As illustrated, in this embodiment, when the system is operating in the discharge mode, optional regeneration unit 106 need not be in the flow path represented by the solid lines.

An advantage of fuel cells relative to traditional power sources such as lead acid batteries is that they can provide longer term primary and/or auxiliary/backup power more efficiently and compactly. This advantage stems from the ability to continuously refuel the fuel cells using fuel stored with the fuel cell, from some other source, and/or regenerated from reaction products by the optional regeneration unit 106. In the case of the metal (e.g., zinc) fuel cell, for example, the duration of time over which energy can be provided is limited only by the amount of fuel and reaction medium (if used) which is initially provided in the fuel storage unit, which is fed into the system during replacement of a fuel storage unit 108, and/or which can be regenerated from the reaction products that are produced. Thus, the system, comprising at least one fuel cell that comprises an optional regeneration unit 106 and/or a replaceable fuel storage unit 108, can provide primary and/or auxiliary/backup power to the one or more loads for a time in the range(s) from about 0.01 hours to about 10000 hours, or even more. In one aspect of this embodiment, the system can provide back-up power to the one or more loads for a time in the range(s) from about 0.5 hours to about 650 hours, or even more.

Moreover, the system can optionally can be configured to expel substantially no reaction product(s) outside of the system (e.g., into the environment).

Embodiments of the Invention

With reference to FIG. 1C, the invention comprises an apparatus 10 for monitoring at least one individual cell(s) FC in a fuel cell of an electrochemical power source. The monitoring apparatus comprises at least one individual cell(s), a first switch network 14, a capacitor C, a second switch network 18, and a voltage measurement circuit 20. The at least one individual cell(s) can be electrically coupled (in series and/or in parallel) between terminals 22+ and 22− of a bus of the power source. The first switch network can be coupled between the at least one individual cell(s) and the capacitor for momentarily coupling one or more selected individual cell(s) to the capacitor for inducing a voltage from the selected individual cell(s) onto the capacitor. The second switch network can be coupled between the capacitor and the voltage measurement circuit for momentarily coupling the capacitor to the measurement circuit to permit the measurement circuit to measure the induced voltage across the capacitor for monitoring the selected individual cell(s).

In one embodiment, the capacitor C can comprise a floating capacitor that is electrically isolated from a reference voltage of the monitoring apparatus 10 when not coupled by the second switch network 18 to the voltage measurement circuit 20. Alternatively or in addition, the reference voltage can comprise an electrical system ground for the monitoring apparatus. Alternatively or in addition, the momentary coupling between the selected individual cell(s) FC and the capacitor by the first switch network and the momentary coupling between the capacitor and the voltage measurement circuit by the second switch network 18 typically is timed such that no simultaneous current circuit path exists between selected individual cell(s) and the voltage measurement circuit through the first and second switch networks. Individual cells of a cell stack are capable of generating DC currents exceeding 100 amperes (A) and an inadvertent current path could have severe consequences. Also, ground loop potentials can exist between the fuel cell and the voltage measurement circuit impeding accurate measurement of the individual cell output voltages.

The monitoring apparatus 10 further can comprise one or more logic (e.g., microprocessor) 24, each being utilized for controlling the first and second network switches, 14 and 18, for obtaining the measured voltages from the measurement circuit 20, and/or for determining and/or indicating whether the selected individual cell(s) is operating within predetermined voltage limits.

In one embodiment, the individual cell(s) FC can be configured in a series-connected cell stack of 24 cells, although parallel-connected individual cells and/or greater or fewer individual cells comprising the cell stack are contemplated in accordance with the invention. The monitoring apparatus allows the health of individual cell(s) (or group(s) of such individual cell(s)) in the stack to be monitored based on the individual cell(s)' (or group(s)') output voltage.

Typically, individual cell(s) of a cell stack of a fuel cell (or group(s) of such individual cell(s)) is/are determined to be healthy if its voltage is not less than a value in the range(s) from about 10% to about 50% of its normal, theoretical operating voltage. Conversely, individual cell(s) of a cell stack of a fuel cell (or group(s) of such individual cell(s)) is/are determined to be unhealthy if its voltage is less than a value in the range(s) from about 10% to about 50% of its normal, theoretical operating voltage. In an embodiment, where an exemplary zinc individual cell FC that produces a direct current (DC) output voltage is deemed to be healthy, the normal, theoretical operating voltage is about 1.5 volts and the predetermined voltage limits are selected to be not less than about 20% of this normal, theoretical operating voltage, these predetermined voltage limits vary in the range(s) between about 0.3 and about 1.5 volts. In an alternative and/or additional embodiment, where an exemplary zinc individual cell FC that produces a direct current (DC) output voltage is deemed to be unhealthy, the normal, theoretical operating voltage is about 1.5 volts and the predetermined voltage limits are selected to be not less than about 20% of this normal, theoretical operating voltage, these predetermined voltage limits vary in the range(s) of less than about 0.3 volts.

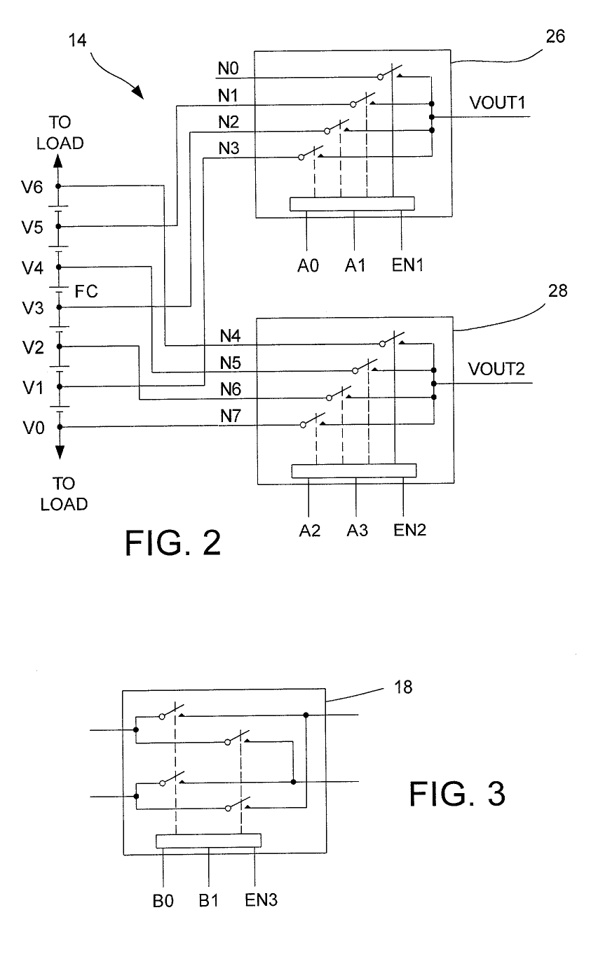

With reference to FIGS. 2 and 3, although only 6 individual cells are shown, the switching technique can be scaled to less or more individual cells. In one example, the switching technique can be scaled to a number of individual cells in the range(s) from 2 to 10000.

With reference to FIG. 2, the first switch network can comprise first and second multiplexers, 26 and 28, to minimize the number of wire connections to the individual cells FC. The first multiplexer comprises inputs N0, N1, N2 and N3, output VOUT1, select lines A0 and A1, and enable line EN1. The select lines A0 and A1 can be set by the logic 24 for selecting one of the internal switches. The selected switch can be momentarily closed while the enable line is set. The second multiplexer similarly comprises inputs N4, N5, N6 and N7, output VOUT2, select lines A2 and A3, and enable line EN2.

In this example, the voltage(s) of the individual cell(s) can be measured individually. To measure the voltage of the first individual cell FC, the first multiplexer 26 can be configured to couple the input N3 to the first output VOUT1, and the second multiplexer 28 can be configured to couple the input N7 to the second output VOUT2 such that voltage at the first output VOUT1 can be equal to the voltage V1 at the positive terminal of the first individual cell and the voltage at the second output VOUT2 can be equal to the voltage V0 at the negative terminal of the first individual cell. Once the capacitor is fully charged, the enable lines EN1 and EN2 can be released and the second switch network 18 then can couple the capacitor to the voltage measurement circuit 20. The induced voltage across the capacitor is equal to the difference between the voltage V1 and the voltage V0. To measure the voltage of the second individual cell, the first output VOUT1 can remain coupled to the input N3 and the second multiplexer can be configured to couple the input N6 to the second output VOUT2. The resulting induced voltage across the capacitor is equal to the voltage difference between the voltage V1 and the voltage V2. Note, however, that the induced voltage of the second individual cell is inverted on the capacitor.

Thus, in a further embodiment of the invention, the second switch network can selectably couple the capacitor to the measurement circuit such that the voltage measured by the measurement circuit is inverted. In this embodiment with reference to FIG. 2, the second switch network can be configured to invert, under control of the logic (e.g., microprocessor) 24 using enable line EN3 and select lines B0 and B1, the capacitor terminals when the capacitor is coupled to the voltage measurement circuit. The first and second multiplexers, 26 and 28, can use multiplexer part number MAX4508 available from Maxium Integrated Products, Inc. (Sunnyvale, Calif.) (www.maxim-ic.com). The second switch network 18 can use multiplexer part number MAX4509 also available from Maxium Integrated Products, Inc.

In an additional aspect, the invention comprises testing apparatus that can be configured in substantially the same way as the monitoring apparatus in accordance with the invention.

In another aspect, the invention comprises suitable components, or subcombinations of the elements, of an apparatus in accordance with the invention.

In an additional aspect, the invention pertains to fuel cell subsystems. As utilized herein, “fuel cell subsystems” include without limitation systems comprising monitoring and/or testing apparatus in an amount in the range(s) from about 1 to about 100, each independently prepared in accordance with the invention, and one or more other components of a fuel cell. These components include without limitation cathode(s) (e.g., the cathode(s) described in U.S. patent application Ser. No. 10/050,901, Entitled “Polymer Composites, Electrodes, and Systems Thereof,” Filed Oct. 19, 2001, Attorney Docket 04813.0025.NPUS00, incorporated herein by this reference), anode(s) (e.g., the recirculating anode(s) described in U.S. patent application Ser. No. 10/060,965, Entitled “A Recirculating Zinc Anode for the Production of Electrical Power,” Filed Oct. 19, 2001, Attorney Docket 04813.0013.NPUS00, incorporated herein by this reference), separator(s), electrolyte, pellet or fuel delivery/feeding, cell stack, cell frame, cooling mechanism, air management mechanism, optional fuel regenerator, electronics/control system, and the like, and suitable combinations of any two or more thereof. Although these fuel cell subsystems can comprise monitoring and/or testing apparatus according to the invention, the specific number and/or types of monitoring and/or testing apparatus can be varied depending on the intended use or application of the fuel cell subsystem. Thus, for use in fuel cells and use to test operability of various fuel cell components, these fuel cell subsystems can vary as discussed above, and, in one non-limiting example, can comprise at least one monitoring and/or testing apparatus comprising a plurality of individual cells, a first switch network 14, a capacitor C, a second switch network 18, and a voltage measurement circuit 20.

In a further aspect, the invention comprises novel fuel cells. Typically, these fuel cells comprise at least one monitoring and/or testing apparatus in accordance with the invention. The specific number and/or types of monitoring and/or testing apparatus can be varied depending on the intended use or application of the fuel cell. Fuel cells can be customized according to the desired load being serviced. For example, such loads include, without limitation, lawn & garden equipment; radios; telephone; targeting equipment; battery rechargers; laptops; communications devices; sensors; night vision equipment; camping equipment (including without limitation, stoves, lanterns, lights, and the like); lights; vehicles (including without limitation, cars, recreational vehicles, trucks, boats, ferries, motorcycles, motorized scooters, forklifts, golf carts, lawnmowers, industrial carts, passenger carts (airport), luggage handling equipment (airports), airplanes, lighter than air crafts (e.g., blimps, dirigibles, and the like), hovercrafts, trains (e.g., locomotives, and the like), and submarines (manned and unmanned); torpedoes; security systems; electrical energy storage devices for renewable energy sources (e.g., solar-based, tidal-based, hydro-based, wind-based, and the like); many other types of electrical devices, equipment for which a primary and/or backup power source is necessary or desirable to enable the equipment to function for its intended purpose, military-usable variants of above, and the like; and suitable combinations of any two or more thereof.

In another aspect, the invention comprises methods for monitoring at least one individual cell(s) in a fuel cell of an electrochemical power source. In an additional aspect, the invention comprises methods for testing the health of at least one individual cell of a cell stack of a fuel cell and/or the fuel cell stack itself.

Monitoring and/or testing method(s) according to the invention can comprise selecting for a voltage measurement one or more individual cell(s) from a plurality of individual cells that are electrically coupled (in series and/or in parallel) between the terminals of a bus of the electrochemical power source. The method(s) further can comprise coupling the selected individual cell(s) to a floating capacitor to induce the voltage of the selected individual cell(s) onto the floating capacitor. The method(s) also can comprise electrically isolating (e.g., disconnecting) the floating capacitor from the selected individual cell(s). The method(s) then can comprise coupling the floating capacitor to a measurement circuit for measuring the floating capacitor's induced voltage for monitoring the selected individual cell(s)' voltage(s). The method(s) optionally can be repeated for one or more of the remaining individual cell(s) in the fuel cell stack. The method(s) further can comprise determining and/or indicating whether the selected individual cell(s) is operating within a predetermined voltage range.

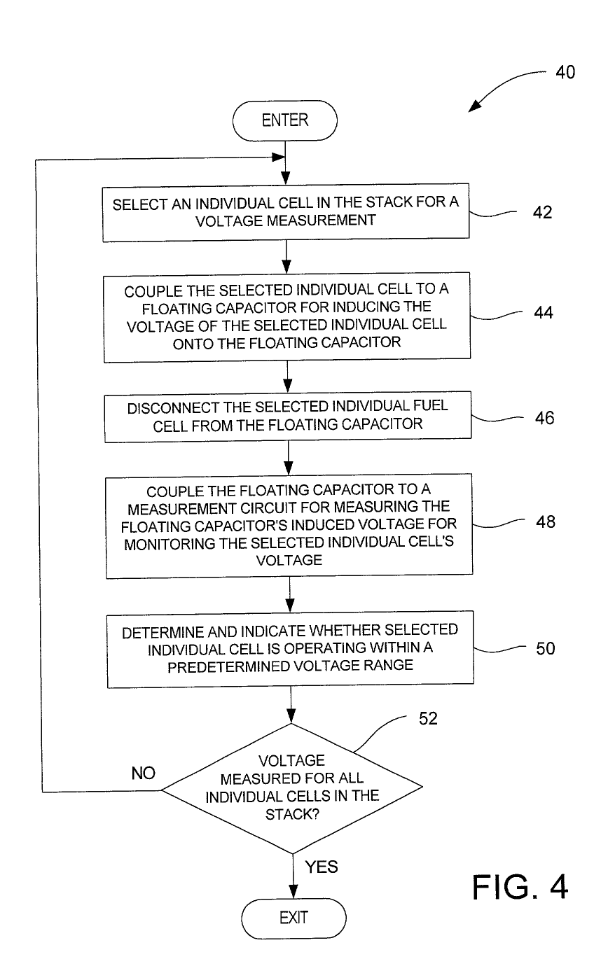

The monitoring and/or testing method(s) according to the invention are exemplified by the following non-limiting description of a monitoring method illustrated in FIG. 4. FIG. 4 shows a method 40 for monitoring an individual cell FC in a stack of series-connected individual cells. An individual cell in the stack is selected for a voltage measurement (step 42). The selected individual cell is coupled to a floating capacitor C for inducing the voltage of the individual cell onto the floating capacitor (step 44). The floating capacitor is then disconnected from the selected individual cell (step 46). The floating capacitor is then coupled to a measurement circuit 20 for measuring the floating capacitor's induced voltage for monitoring the selected individual cell's voltage (step 48). The logic (e.g., microprocessor) 24 can then determine and/or indicate whether the selected individual cell is operated within a predetermined voltage range (step 50). The method can be repeated for a plurality of, and up to each, individual cell in the stack (step 52), or, alternatively or in addition, for one or more group(s) of individual cell(s) in the stack (not shown).

In an additional aspect, the invention comprises suitable submethods, or subcombinations of the steps, of a method in accordance with the invention.

While the invention has been illustrated and described in detail in the drawings and foregoing description, it should be understood the invention may be implemented though alternative embodiments within the spirit of the invention. Thus, the scope of the invention is not intended to be limited to the illustration and description in this specification, but is to be defined by the appended claims.

What is claimed is:

1. An apparatus for monitoring one or more individual cell(s) in an electrochemical power source comprising a fuel cell, the apparatus comprising:
at least one of the one or more individual cell(s);
a capacitor;
a first switch network coupled between the at least one individual cell(s) and the capacitor that can be operatively engaged to momentarily couple the at least one individual cell(s) to the capacitor for inducing a voltage from the at least one individual cell(s) onto the capacitor;
a voltage measurement circuit; and
a second switch network coupled between the capacitor and the voltage measurement circuit that can be operatively engaged to momentarily couple the capacitor to the voltage measurement circuit for permitting the measurement circuit to measure the induced voltage across the capacitor for monitoring the at least one individual cell(s).

2. The apparatus of claim 1, wherein the electrochemical power source further comprises a bus comprising terminals, and wherein the one or more individual cell(s) comprise a plurality of individual cells that are electrically coupled between the terminals in series or in parallel.

3. The apparatus of claim 1, wherein the individual cells are electrically coupled between the terminals in series.

4. The apparatus of claim 1, wherein the capacitor comprises a floating capacitor that is electrically isolated from a reference voltage of the apparatus when not coupled by the second switch network to the voltage measurement circuit.

5. The apparatus of claim 1, wherein a reference voltage of the apparatus comprises an electrical system ground for the monitoring apparatus.

6. The apparatus of claim 1, wherein the momentary coupling between the at least one individual cell(s) and the capacitor by the first switch network and the momentary coupling between the capacitor and the voltage measurement circuit are timed such that no simultaneous current circuit path exists between the at least one individual cell(s) and the voltage measurement circuit through the first and second switch networks.

7. The apparatus of claim 1, further comprising means for determining whether the at least one individual cell(s) is operating within predetermined limits based on the measurement of the induced voltage of the capacitor.

8. The apparatus of claim 1, wherein the second switch network can be operatively engaged to selectably couple the capacitor to the measurement circuit such that the voltage measured by the measurement circuit is inverted.

9. The apparatus of claim 1, wherein the fuel cell is selected from a hydrogen fuel cell or a metal fuel cell.

10. The apparatus of claim 9, wherein the fuel cell is a metal fuel cell.

11. The apparatus of claim 10, wherein the metal fuel cell is a zinc fuel cell.

12. The apparatus of claim 1, wherein the fuel cell comprises one or more of the following properties: the fuel cell is configured to not utilize or produce significant quantities of flammable fuel or product, respectively; the fuel cell provides primary and/or auxiliary/backup power to one or more loads for an amount of time in the range from about 0.01 hours to about 10,000 hours; the fuel cell is configured to have an energy density in the range from about 35 Watt-hours per kilogram of combined fuel and reaction medium added to about 400 Watt-hours per kilogram of combined fuel and reaction medium added; the fuel cell comprises an energy requirement in the range from 5×10⁻¹² Watt-hours to about 50,000,000 Watt-hours, and can be configured such that the combined volume of fuel and reaction medium added to the fuel cell is in the range from about 0.0028 L per Watt-hour of the fuel cell's energy requirement to about 0.025 L per Watt-hour of the fuel cell's energy requirement; the fuel cell comprises a fuel storage unit that can store fuel at an internal pressure in the range from about −5 pounds per square inch (psi) gauge pressure to about 200 psi gauge pressure; the fuel cell is configured to operate normally while generating noise in the range from about 1 dB to about 30 dB, when measured at a distance of about 10 meters therefrom.

13. An apparatus for testing the health of one or more individual cell(s) in an electrochemical power source comprising a fuel cell, the apparatus comprising:
at least one of the one or more individual cell(s);
a capacitor;
a first switch network coupled between the at least one individual cell(s) and the capacitor that can be operatively engaged to momentarily couple the at least one individual cell(s) to the capacitor for inducing a voltage from the at least one individual cell(s) onto the capacitor;
a voltage measurement circuit; and
a second switch network coupled between the capacitor and the voltage measurement circuit that can be operatively engaged to momentarily couple the capacitor to the voltage measurement circuit for permitting the measurement circuit to measure the induced voltage across the capacitor for testing the health of the at least one individual cell(s).

14. The apparatus of claim 13, wherein the one or more individual cell(s) each comprise a normal, theoretical operating voltage, and the health of the one or more individual cell(s) is determined by an induced voltage not less than a value in the range from about 10% to about 50% of the normal, theoretical operating voltage for the one or more individual cell(s).

15. The apparatus of claim 14, wherein the health of the one or more individual cell(s) is determined by an induced voltage not less than about 20% of the normal, theoretical operating voltage for the one or more individual cell(s).

16. The apparatus of claim 14, wherein the health of the one or more individual cell(s) is determined by an induced voltage not less than about 40% of the normal, theoretical operating voltage for the one or more individual cell(s).

17. A fuel cell subsystem comprising at least one apparatus according to claim 1 or 13.

18. A fuel cell comprising at least one apparatus according to claim 1 or 13.

19. A method for monitoring the voltage of at least one individual cell(s) in a fuel cell of an electrochemical power source, the method comprising:
a. selecting for a voltage measurement one or more individual cell(s) that are electrically coupled between the terminals of a bus of the electrochemical power source;
b. coupling the selected individual cell(s) to a floating capacitor for inducing the voltage of the selected individual cell(s) onto the floating capacitor;
c. disconnecting the selected individual cell(s) from the floating capacitor; and
d. coupling the floating capacitor to a measurement circuit for measuring the floating capacitor's induced voltage for monitoring the selected individual cell(s)' voltage.

20. The method of claim 19, further comprising repeating steps a, b, c and d for one or more additional individual cell(s) in the fuel cell.

21. The method of claim 19, further comprising repeating steps a, b, c and d for all of the additional individual cell(s) in the fuel cell.

22. The method of claim 19, further comprising determining, for each of the selected individual cell(s), whether the selected individual cell is operating within a predetermined voltage range.

23. The method of claim 20, further comprising determining, for each of the selected individual cell(s), whether the selected individual cell is operating within a predetermined voltage range.

24. The method of claim 21, further comprising determining, for each of the selected individual cell(s), whether the selected individual cell is operating within a predetermined voltage range.

25. The method of claim 22, further comprising indicating, for each of the selected individual cell(s), whether the selected individual cell is operating within a predetermined voltage range.

26. The method of claim 23, further comprising indicating, for each of the selected individual cell(s), whether the selected individual cell is operating within a predetermined voltage range.

27. The method of claim 24, further comprising indicating, for each of the selected individual cell(s), whether the selected individual cell is operating within a predetermined voltage range.

28. A method for monitoring the health of at least one individual cell(s) in a fuel cell of an electrochemical power source, the method comprising:
a. selecting for a voltage measurement one or more individual cell(s) that are electrically coupled between the terminals of a bus of the electrochemical power source;
b. coupling the selected individual cell(s) to a floating capacitor for inducing the voltage of the selected individual cell(s) onto the floating capacitor;
c. disconnecting the selected individual cell(s) from the floating capacitor; and
d. coupling the floating capacitor to a measurement circuit for measuring the floating capacitor's induced voltage for monitoring the selected individual cell(s)' voltage; and
e. determining, for each of the selected individual cell(s), whether the selected individual cell is operating at not less than a predetermined voltage.

29. The method of claim 28, further comprising repeating steps a, b, c, d and e for one or more additional individual cell(s) in the fuel cell.

30. The method of claim 28, further comprising repeating steps a, b, c, d and e for all of the additional individual cell(s) in the fuel cell.

31. The method of claim 28, further comprising indicating, for each of the selected individual cell(s), whether the selected individual cell is operating above a predetermined voltage.

32. The method of claim 29, further comprising indicating, for each of the selected individual cell(s), whether the selected individual cell is operating above a predetermined voltage.

33. The method of claim 30, further comprising indicating, for each of the selected individual cell(s), whether the selected individual cell is operating above a predetermined voltage.

34. An apparatus for monitoring one or more individual cell(s) in an electrochemical power source comprising a fuel cell, the apparatus comprising:
at least one of the one or more individual cell(s) comprising selected individual cell(s), the selected individual cell(s)comprising a first terminal and a second terminal;
a capacitor comprising first and second terminals;
a first switch network comprising first and second output terminals coupled, respectively, to the capacitor's first and second terminals, and further comprising a plurality of selectable input terminals that can be switch coupled to the first switch network's output terminals, and a control interface for receiving control data for momentarily coupling the terminals of the selected individual cell(s) to the terminals of the capacitor through the first switch network for inducing a voltage from the selected fuel cell onto the capacitor;
a voltage measurement circuit comprising first and second terminals; and
a second switch network coupled that can be operatively engaged to momentarily couple the capacitor terminals to the voltage measurement circuit terminals through the second switch network for permitting the measurement circuit to measure the induced voltage across the capacitor terminals for monitoring the selected individual cell(s).

35. The apparatus of claim 34, wherein the electrochemical power source further comprises a bus comprising terminals, and wherein the selected individual cell(s) comprise a plurality of individual cells that are electrically coupled between the terminals in series or in parallel.

36. The apparatus of claim 35, wherein the individual cells are electrically coupled between the terminals in series.

37. The apparatus of claim 34, wherein the capacitor comprises a floating capacitor comprising both terminals electrically isolated from a reference voltage of the monitoring apparatus when the capacitor terminals are not coupled by the second switch network to the voltage measurement circuit.

38. The apparatus of claim 34, wherein a reference voltage of the monitoring apparatus is a ground terminal on the monitoring apparatus.

39. The apparatus of claim 34, wherein the momentary coupling of the terminals of the selected individual cell(s) to the terminals of the capacitor through the first switch network and the momentary coupling of the terminals of the capacitor and the terminals of the voltage measurement circuit are timed such that no simultaneous current circuit path exists between the selected individual cell(s) and the voltage measurement circuit through the first and second switch networks.

40. The apparatus of claim 34, further comprising means for determining whether the selected individual cell(s) is operating within predetermined limits based on the measurement of the induced voltage of the capacitor.

41. The apparatus of claim 34, wherein the second switch network can be operatively engaged to selectably couple the capacitor to the measurement circuit such that the voltage measured by the measurement circuit is inverted.

42. The apparatus of claim 34, wherein the fuel cell is selected from a hydrogen fuel cell or a metal fuel cell.

43. The apparatus of claim 42, wherein the fuel cell is a metal fuel cell.

44. The apparatus of claim 43, wherein the metal fuel cell is a zinc fuel cell.

45. The apparatus of claim 34, wherein the fuel cell comprises one or more of the following properties: the fuel cell is configured to not utilize or produce significant quantities of flammable fuel or product, respectively; the fuel cell provides primary and/or auxiliary/backup power to one or more loads for an amount of time in the range from about 0.01 hours to about 10,000 hours; the fuel cell is configured to have an energy density in the range from about 35 Watt-hours per kilogram of combined fuel and reaction medium added to about 400 Watt-hours per kilogram of combined fuel and reaction medium added; the fuel cell comprises an energy requirement in the range from 5×10⁻¹² Watt-hours to about 50,000,000 Watt-hours, and can be configured such that the combined volume of fuel and reaction medium added to the fuel cell is in the range from about 0.0028 L per Watt-hour of the fuel cell's energy requirement to about 0.025 L per Watt-hour of the fuel cell's energy requirement; the fuel cell comprises a fuel storage unit that can store fuel at an internal pressure in the range from about −5 pounds per square inch (psi) gauge pressure to about 200 psi gauge pressure; the fuel cell is configured to operate normally while generating noise in the range from about 1 dB to about 30 dB, when measured at a distance of about 10 meters therefrom.
